(19) United States
(12) Patent Application Publication
(10) Pub. No.: US 2013/0076641 A1
(43) Pub. Date: Mar. 28, 2013

(54) Method and Keyboard for Inputting Chinese Characters and Electronic Apparatus Containing the Keyboard

(71) Applicant: Changtan LI, Beijing (CN)

(72) Inventor: Changtan LI, Beijing (CN)

(73) Assignee: SONY MOBILE COMMUNICATIONS AB, Lund (SE)

(21) Appl. No.: 13/611,693

(22) Filed: Sep. 12, 2012

(30) Foreign Application Priority Data
Sep. 28, 2011 (CN) 201110299693.5

(51) Int. Cl. G06F 3/02

(52) U.S. Cl. 345/171

(57) ABSTRACT

The embodiments of the present invention provide a method and a keyboard for inputting Chinese characters and electronic apparatus containing the keyboard, wherein the method is applicable to Chinese characters input on a keyboard. The keyboard includes an initial consonant inputting region and a compound vowel inputting region, the initial consonant inputting region including multiple initial consonant keys, with each of the initial consonant keys indicating at least one initial consonant, and the compound vowel inputting region including multiple compound vowel keys, with each of the compound vowel keys indicating at least one compound vowel. The method for inputting Chinese characters including the steps of: acquiring corresponding initial consonant and compound vowel(s) or acquiring corresponding compound vowel and displaying the Chinese character consistent with the combination of the initial consonant and compound vowel(s) or the Chinese character consistent with the compound vowel in accordance with a predefined rule.

### TECHNICAL FIELD

The present invention relates to electronics and communication fields and in particular to a method and keyboard for inputting Chinese characters and electronic apparatus containing the keyboard.

### BACKGROUND ART

With the rapid development of electronic and communication technologies, some electronic apparatuses, such as mobile phones, have become indispensable for daily lives of the people. Many functions are incorporated into them, bringing much convenience to the lives and works of the people. Keyboards for inputting information have become indispensable parts of these electronic apparatuses.

FIG. 1 is a schematic diagram of a typical keyboard of a mobile phone. As shown in FIG. 1, the keyboard mainly includes a functional input region 11 and a content input region 12. The functional input region 11 includes keys for inputting various functions, such as an Enter (select) key, a Direction key, a Delete key, an Answer key, and a Hangup key, etc., with each of the keys representing a meaning. The content input region 12 includes keys for inputting various contents, such as the keys for inputting digits and/or letters and/or strokes, with each of the keys representing multiple meanings. In the content input region 12 of the key structure shown in FIG. 1, the same key may input letters or strokes, in addition to inputting digits, and different contents may be inputted through switching the input modes. For example, the key for inputting digit “2” may also input stroke “|” or letter “a”, “b” or “c”. Such a keyboard shown in FIG. 1 necessarily increases the complexity of the input process when inputting a text as the same key represents multiple meanings, reducing the efficiency of input.

FIG. 2 is a schematic diagram of a keyboard of another mobile phone. As shown in FIG. 2, in such a keyboard structure, also referred to as a full-keyboard structure, the defect existing in the keyboard shown in FIG. 1 is overcome. Each of the keys in the functional input region 21 represents a meaning, and each of the keys in the content input region 22 also represents a meaning, similar to those commonly used in a computer. Such a key structure shown in FIG. 2 simplifies the complexity of input as each of the keys in the content input region 22 represents a meaning, which is more suitable for the habits of users, thereby, improving the efficiency of input to some extent.

With the advantages of the full-keyboard structure shown in FIG. 2, virtual keyboards of many touch-screen mobile phones also adopt such a full-keyboard structure.

### SUMMARY OF THE INVENTION

In the implementation of the present invention, the applicant found that although the full-keyboard structure shown in FIG. 2 improves the efficiency of input to some extent, it uses the design principle of a keyboard commonly used in a computer, i.e. it is designed for inputting with both hands according to the habit of inputting English. For a mobile phone with a limited area of key region, the input efficiency as that of a keyboard commonly used in a computer cannot be achieved when a user inputs a text, especially inputs Chinese characters, with two thumbs by using a keyboard with such a full-keyboard structure.

The present invention is proposed in view of the above defects.

The present invention is addressed to provide a method and keyboard for inputting Chinese characters and electronic apparatus containing the keyboard, so as to improve the input efficiency of the electronic apparatus in inputting Chinese characters.

According to a first aspect of the present invention, there is provided a method for inputting Chinese characters, applicable to Chinese characters input on a keyboard. The keyboard includes an initial consonant inputting region and a compound vowel inputting region, the initial consonant inputting region including multiple initial consonant keys, with each of the initial consonant keys indicating at least one initial consonant, and the compound vowel inputting region including multiple compound vowel keys, with each of the compound vowel keys indicating at least one compound vowel, and the method for inputting Chinese characters including the steps of:

acquiring corresponding initial consonant and compound vowel(s), in response to the input of an initial consonant key in the initial consonant inputting region and the input of a compound vowel key (or compound vowel keys) in the compound vowel inputting region, or, acquiring corresponding compound vowel, in response to the input of a compound vowel key in the compound vowel inputting region; and

displaying the Chinese character consistent with the combination of the initial consonant and compound vowel(s) or the Chinese character consistent with the compound vowel in accordance with a predefined rule.

According to a second aspect of the present invention, there is provided a method as described in the first aspect, wherein the initial consonant inputting region is located at the left side of the keyboard, and the initial consonant keys of the initial consonant inputting region are arranged in an array; and the compound vowel inputting region is located at the right side of the keyboard, and the compound vowel keys of the compound vowel inputting region are arranged in an array.

According to a third aspect of the present invention, there is provided a method as described in the first aspect, wherein the number of the initial consonant keys of the initial consonant inputting region is 20, and the initial consonant keys are arranged in an array of 4×5 and wherein the initial consonant “z” and the initial consonant “zh” correspond to an initial consonant key, the initial consonant “c” and the initial consonant “ch” correspond to an initial consonant key, the initial consonant “s” and the initial consonant “sh” correspond to an initial consonant key, and each of other initial consonants corresponds to an initial consonant key.

According to a fourth aspect of the present invention, there is provided a method as described in the first aspect, wherein the number of the initial consonant keys of the initial consonant inputting region is 23, and the initial consonants are arranged in an array of 5×5, wherein each of the initial consonants corresponds to an initial consonant key.

According to a fifth aspect of the present invention, there is provided a method as described in the first aspect, wherein the number of the compound vowel keys of the compound vowel inputting region is 20, and the compound vowel keys are arranged in an array of 4×5 and wherein the compound vowel “an” and the compound vowel “ang” correspond to a compound vowel key, the compound vowel “en” and the compound vowel eng correspond to a compound vowel key, the compound vowel “in” and the compound vowel “ing” correspond to a compound vowel key, the compound vowel “un” and the compound vowel “ong” correspond to a compound vowel key, and each of other compound vowels corresponds to a compound vowel key.

According to a sixth aspect of the present invention, there is provided a method as described in the first aspect, wherein the number of the compound vowel keys of the compound vowel inputting region is 24, and the compound vowels are arranged in an array of 5×5, wherein each of the compound vowels corresponds to a compound vowel key.

According to a seventh aspect of the present invention, there is provided a keyboard, applicable to Chinese characters input, wherein the keyboard includes:

an initial consonant inputting region, including multiple initial consonant keys, with each of the initial consonant keys indicating at least one initial consonant; and

a compound vowel inputting region, including multiple compound vowel keys, with each of the compound vowel keys indicating at least one compound vowel.

According to an eighth aspect of the present invention, there is provided a keyboard as described in the seventh aspect, wherein the initial consonant inputting region is located at the left side of the key structure, and the initial consonant keys of the initial consonant inputting region are arranged in an array and the compound vowel inputting region is located at the right side of the key structure, and the compound vowel keys of the compound vowel inputting region are arranged in an array.

According to a ninth aspect of the present invention, there is provided a keyboard as described in the seventh aspect, wherein the number of the initial consonant keys of the initial consonant inputting region is 20, and the initial consonant keys are arranged in an array of 4×5 and wherein the initial consonant “z” and the initial consonant “zh” correspond to an initial consonant key, the initial consonant “c” and the initial consonant “ch” correspond to an initial consonant key, the initial consonant “s” and the initial consonant “sh” correspond to an initial consonant key, and each of other initial consonants corresponds to an initial consonant key.

According to a tenth aspect of the present invention, there is provided a keyboard as described in the seventh aspect, wherein the number of the initial consonant keys of the initial consonant inputting region is 23, and the initial consonants are arranged in an array of 5×5, wherein each of the initial consonants corresponds to an initial consonant key.

According to an eleventh aspect of the present invention, there is provided a keyboard as described in the seventh aspect, wherein the number of the compound vowel keys of the compound vowel inputting region is 20, and the compound vowel keys are arranged in an array of 4×5, wherein the compound vowel “an” and the compound vowel “ang” correspond to a compound vowel key, the compound vowel “en” and the compound vowel “eng” correspond to a compound vowel key, the compound vowel “in” and the compound vowel “ing” correspond to a compound vowel key, the compound vowel “un” and the compound vowel “ong” correspond to a compound vowel key, and each of other compound vowels corresponds to a compound vowel key.

According to a twelfth aspect of the present invention, there is provided a keyboard as described in the seventh aspect, wherein the number of the compound vowel keys of the compound vowel inputting region is 24, and the compound vowels are arranged in an array of 5×5, wherein each of the compound vowels corresponds to a compound vowel key.

According to a thirteenth aspect of the present invention, there is provided an electronic apparatus, including the keyboard as described in any one of the seventh to the thirteenth aspects, for inputting Chinese characters through the keyboard.

The method and keyboard for inputting Chinese characters and electronic apparatus containing the keyboard provided by the present invention is more suitable for the habits of inputting Chinese characters, thereby, improving the efficiency of electronic apparatus in inputting Chinese characters.

These and further aspects and features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

Many aspects of the invention can be better understood with reference to the following drawings. The components in the drawings are not necessarily to scale, emphasis instead being placed upon clearly illustrating the principles of the present invention. To facilitate illustrating and describing, some parts of the invention, corresponding portions of the drawings may be exaggerated in size, e.g., made larger in relation to other parts than in an exemplary device actually made according to the invention. Elements and features depicted in one drawing or embodiment of the invention may be combined with elements and features depicted in one or more additional drawings or embodiments. Moreover, in the drawings, like reference numerals designate corresponding parts throughout the several views and may be used to designate like or similar parts in more than one embodiment.

### BRIEF DESCRIPTION OF THE DRAWINGS

The drawings are included to provide further understanding of the present invention, which constitute a part of the specification and illustrate the preferred embodiments of the present invention, and are used for setting forth the principles of the present invention together with the description. The same element is represented with the same reference number throughout the drawings.

In the drawings:

FIG. 1 is a schematic diagram of a keyboard of a conventional mobile phone;

FIG. 2 is a schematic diagram of a keyboard of another conventional mobile phone;

FIG. 3 is a flowchart of the method for inputting Chinese characters of the embodiments of the present invention;

FIG. 4 is a schematic diagram of a keyboard of the embodiments of the present invention; and

FIG. 5 is a schematic diagram of another keyboard of the embodiments of the present invention.

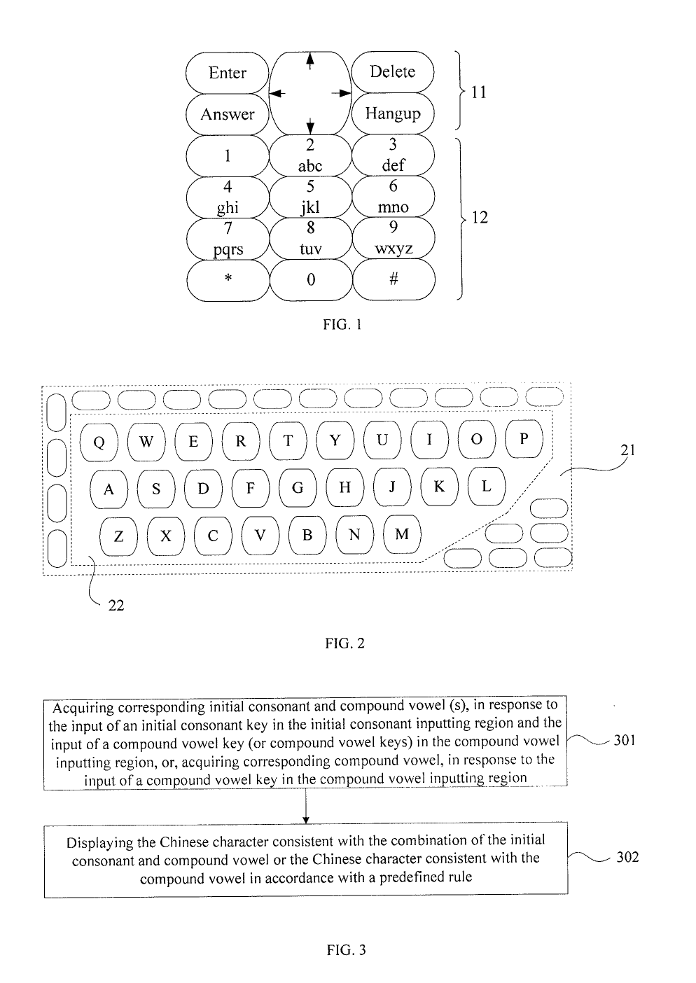

### DETAILED DESCRIPTION OF THE INVENTION

The interchangeable terms “electronic apparatus” and “electronic device” include portable radio communication apparatus. The term “portable radio communication apparatus”, which hereinafter is referred to as a “mobile terminal”, “portable electronic device”, or “portable communication device”, includes all apparatuses such as mobile telephones, pagers, communicators, electronic organizers, personal digital assistants (PDAs), smartphones, portable communication devices or the like.

In the present application, embodiments of the invention are described primarily in the context of a portable electronic device in the form of a mobile telephone (also referred to as “mobile phone”). However, it shall be appreciated that the invention is not limited to the context of a mobile telephone and may relate to any type of appropriate electronic apparatus having the function of photographing and sound recording.

The preferred embodiments of the present invention will be described as follows with reference to the drawings.

### Embodiment 1

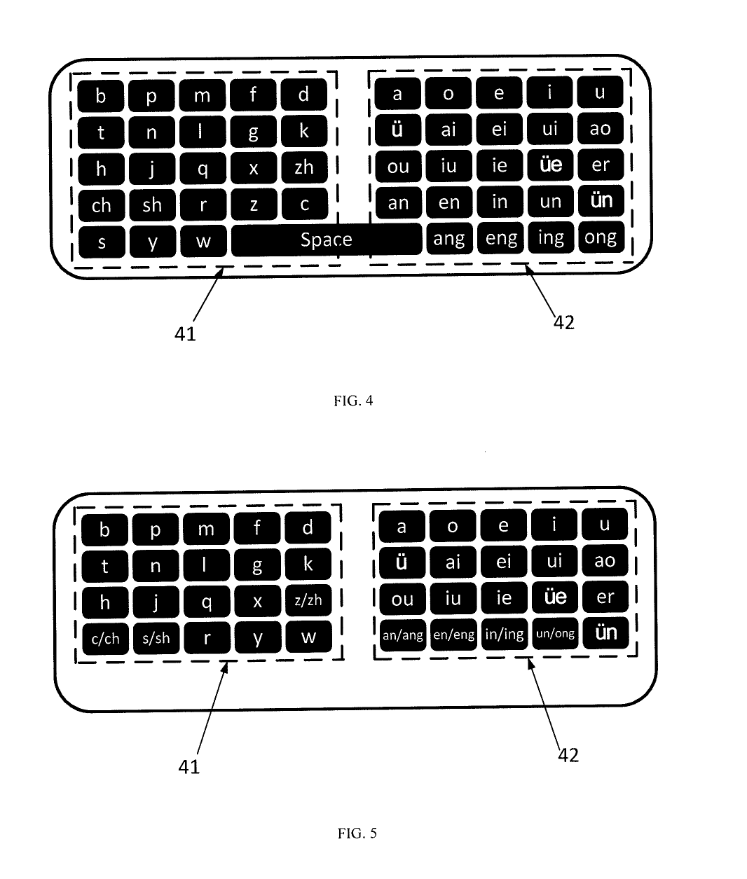

According to an embodiment of the present invention, there is provided a method for inputting Chinese characters. FIG. 3 is a flowchart of the method for inputting Chinese characters of the embodiments of the present invention, applicable to the keyboard shown in FIG. 4. Referring to FIG. 4, the keyboard includes an initial consonant inputting region 41 and a compound vowel inputting region 42. The initial consonant inputting region 41 includes multiple initial consonant keys, with each of the initial consonant keys indicating at least one initial consonant, and the number of the initial consonant keys being related to the number of the initial consonants, which will be described in detail in the following embodiments. The compound vowel inputting region 42 includes multiple compound vowel keys, with each of the compound vowel keys indicating at least one compound vowel, and the number of the compound vowel keys being related to the number of the compound vowels, which will be described in detail in the following embodiments.

Referring to FIG. 3, the method for inputting Chinese characters includes the steps of:

step 301: acquiring corresponding initial consonant and compound vowel(s), in response to the input of an initial consonant key in the initial consonant inputting region and the input of a compound vowel key (or compound vowel keys) in the compound vowel inputting region, or, acquiring corresponding compound vowel, in response to the input of a compound vowel key in the compound vowel inputting region; and

step 302: displaying the Chinese character consistent with the combination of the initial consonant and compound vowel(s) or the Chinese character consistent with the compound vowel in accordance with a predefined rule.

When a user inputs a pinyin having an initial consonant and a compound vowel (or compound vowels) via the keyboard shown in FIG. 4, the user first presses an initial consonant key in the initial consonant inputting region, and then presses one or more compound vowel keys in the compound vowel inputting region. Thus, in step 301 of this embodiment, the initial consonant of the pinyin is obtained first in response to the input of the initial consonant key, and then the compound vowel(s) of the pinyin is(are) obtained in response to the input of the compound vowel key(s);

In step 302 of this embodiment, as the result of inputting the Chinese character by the user, the Chinese character consistent with the combination of the initial consonant and the compound vowel(s) is displayed in accordance with a predefined rule through looking up a Chinese character library. The Chinese character library is stored in the database of the electronic apparatus with the keyboard shown in FIG. 4. The Chinese character library may be a user character library, or a universal character library of the existing input mode, and this embodiment is not limited thereto. The predefined rule is predefined for indicating the display order of Chinese characters, which may be a rule for displaying Chinese characters of the existing input mode, such as displaying Chinese characters in accordance with the frequency of use of Chinese characters, or may be other rules, and this embodiment is not limited thereto.

When a user inputs a compound vowel with no initial consonant via the keyboard shown in FIG. 4, the user only presses a compound vowel key in the compound vowel inputting region. Thus, in step 301 of this embodiment, the compound vowel of the pinyin is obtained in response only to the input of the compound vowel key; thereafter, in step 302 of this embodiment, as the result of the inputting the Chinese character by the user, the Chinese character consistent with the compound vowel is displayed in accordance with a predefined rule through looking up a Chinese character library. The meanings of the Chinese character library and the predefined rule are the same as described above, which shall not be described any further.

In an embodiment, the method for inputting Chinese characters of this embodiment is applicable to miniature electronic apparatuses, such as a mobile phone. Since the size of a miniature electronic apparatus is limited, the initial consonant inputting region arranged in the keyboard of the miniature electronic apparatus is located at the left side of the keyboard, and the initial consonant keys of the initial consonant inputting region are arranged in an array. In addition, the compound vowel inputting region is located at the right side of the keyboard, and the compound vowel keys of the compound vowel inputting region are also arranged in an array. In this way, the user may press the initial consonant keys of the initial consonant inputting region with the left thumb, and press the compound vowel keys of the compound vowel inputting region with the right thumb, thereby improving the input efficiency through alternative inputting using the left and right thumbs.

For the initial consonant keys of the initial consonant inputting region, in a preferred embodiment, the number of the initial consonant keys of the initial consonant inputting region is 20, and the initial consonant keys are arranged in an array of 4×5, wherein the initial consonant “z” and the initial consonant “zh” correspond to an initial consonant key, the initial consonant “c” and the initial consonant “ch” correspond to an initial consonant key, the initial consonant “s” and the initial consonant “sh” correspond to an initial consonant key, and each of other initial consonants corresponds to an initial consonant key.

For the initial consonant keys of the initial consonant inputting region, in another preferred embodiment, the number of the initial consonant keys of the initial consonant inputting region is 23, and the initial consonants are arranged in an array of 5×5, wherein each of the initial consonants corresponds to an initial consonant key.

In the above two embodiments, the corresponding relationship between the order of the initial consonants and the initial consonant keys is not limited. For example, the initial consonants may be arranged in an order corresponding to the order of the keys in the above initial consonant key arrays arranged from up to down and from left to right. It may also be that the initial consonants that are frequently used are arranged at the positions that are easy to be contacted by the left thumb according to the frequency of use, for example, at the left side of the whole initial consonant key array.

For the compound vowel keys of the compound vowel inputting region, in a preferred embodiment, the number of the compound vowel keys of the compound vowel inputting region is 20, and the compound vowel keys are arranged in an array of 4×5 and the compound vowel “an” and the compound vowel “ang” correspond to a compound vowel key, the compound vowel “en” and the compound vowel “eng” correspond to a compound vowel key, the compound vowel “in” and the compound vowel “ing” correspond to a compound vowel key, the compound vowel “un” and the compound vowel “ong” correspond to a compound vowel key, and each of other compound vowels corresponds to a compound vowel key.

For the compound vowel keys of the compound vowel inputting region, in another preferred embodiment, the number of the compound vowel keys of the compound vowel inputting region is 24, and the compound vowels are arranged in an array of 5×5 and each of the compound vowels corresponds to a compound vowel key.

In the above two embodiments, the corresponding relationship between the order of the compound vowels and the compound vowel keys is not limited. For example, the compound vowels may be arranged in an order corresponding to the order of the keys in the above compound vowel key arrays arranged from up to down and from left to right. It may also be that the compound vowels that are frequently used are arranged at the positions that are easy to be contacted by the right thumb according to the frequency of use, for example, at the right side of the whole compound vowel key array.

According to the method for inputting Chinese characters of this embodiment, when a user inputs Chinese characters, the complete input of a Chinese character may be realized by only pressing the initial consonant key and the compound vowel key (keys) to which the Chinese character corresponds. This greatly improves the efficiency of input in comparison with the full spelling input mode of the prior art, wherein each letter to which the complete pinyin of the Chinese character corresponds to needs to be pressed so as to realize the complete input of a Chinese character. For example, in inputting a Chinese character “ [symbol] ”, only three times of pressing are needed with the present method, i.e. pressing the initial consonant “zh” and the compound vowels “u” and “ang”; while in the full spelling mode of input of the prior art, six times of pressing are needed.

### Embodiment 2

According to another embodiment of the present invention, there is provided a keyboard. FIG. 4. is a schematic diagram of a keyboard of the embodiments of the present invention. The keyboard may be used by a user for inputting Chinese characters by using the method for inputting Chinese characters shown in FIG. 3. Those contents similar to the method for inputting Chinese characters shown in FIG. 3 shall not be described any further. Referring to FIG. 4, the keyboard includes:

an initial consonant inputting region 41, including multiple initial consonant keys, with each of the initial consonant keys indicating at least one initial consonant; and

a compound vowel inputting region 42, including multiple compound vowel keys, with each of the compound vowel keys indicating at least one compound vowel.

In an embodiment, the keyboard is provided in miniature electronic apparatuses, such as a mobile phone. Since the size of a miniature electronic apparatus is limited, the initial consonant inputting region 41 is located at the left side of the keyboard, and the initial consonant keys of the initial consonant inputting region 41 are arranged in an array. In addition, the compound vowel inputting region 42 is located at the right side of the keyboard, and the compound vowel keys of the compound vowel inputting region 42 are arranged in an array. In this way, the user may press the initial consonant keys of the initial consonant inputting region 41 with the left thumb, and press the compound vowel keys of the compound vowel inputting region 42 with the right thumb, thereby improving the efficiency in inputting through alternative inputting by the left and right thumbs.

For the initial consonant keys of the initial consonant inputting region 41, in a preferred embodiment, as shown in FIG. 5, the number of the initial consonant keys of the initial consonant inputting region 41 is 20, and the initial consonant keys are arranged in an array of 4×5, wherein the initial consonant “z” and the initial consonant “zh” correspond to an initial consonant key, the initial consonant “c” and the initial consonant “ch” correspond to an initial consonant key, the initial consonant “s” and the initial consonant “sh” correspond to an initial consonant key, and each of other initial consonants corresponds to an initial consonant key.

For the initial consonant keys of the initial consonant inputting region 41, in another preferred embodiment, as shown in FIG. 4, the number of the initial consonant keys of the initial consonant inputting region is 23, and the initial consonants are arranged in an array of 5×5, wherein each of the initial consonants corresponds to an initial consonant key.

In the above two embodiments, the initial consonants are arranged in order corresponding to the order of the keys in the initial consonant key array arranged from up to down and from left to right as an example. However, this embodiment is not limited thereto. For example, the order may be that the initial consonants that are used frequently are arranged at the positions that are easy to be contacted by the left thumb according to the frequency of use, for example, at the left side of the whole initial consonant key array.

For the compound vowel keys of the compound vowel inputting region 42, in a preferred embodiment, as shown in FIG. 5, the number of the compound vowel keys of the compound vowel inputting region 42 is 20, and the compound vowel keys are arranged in an array of 4×5 and the compound vowel “an” and the compound vowel “ang” correspond to a compound vowel key, the compound vowel “en” and the compound vowel “eng” correspond to a compound vowel key, the compound vowel “in” and the compound vowel “ing” correspond to a compound vowel key, the compound vowel “un” and the compound vowel “ong” correspond to a compound vowel key, and each of other compound vowels corresponds to a compound vowel key.

For the compound vowel keys of the compound vowel inputting region 42, in another preferred embodiment, as shown in FIG. 4, the number of the compound vowel keys of the compound vowel inputting region is 24, and the compound vowels are arranged in an array of 5×5 and each of the compound vowels corresponds to a compound vowel key.

In the above two embodiments, the compound vowels are arranged in an order corresponding to the order of the keys in the compound vowel key array arranged from up to down and from left to right as an example. However, this embodiment is not limited thereto. For example, the order may be that the compound vowels that are used frequently are arranged at the positions easy to be contacted by the right thumb according to the frequency of use, for example, at the right side of the whole compound vowel key array.

In the embodiment shown in FIG. 4, since each of the keys indicate one initial consonant or compound vowel, a user, who is not good at distinguishing initial consonants “zh” and “z”, or initial consonants “c” and “ch”, or initial consonants “s” and “sh”, or a user, who is not good at distinguishing compound vowels “an” and “ang”, or compound vowels “en” and “eng”, or compound vowels “in” and “ing”, or compound vowels “un” and “ong”, may make one key to indicate two initial consonants or two compound vowels by the setting of “initiate fuzzy syllables”. For example, initial consonants “z” and “zh” may be indicated by the key “z/zh”, initial consonants “c” and “ch” may be indicated by the key “c/ch”, initial consonants “s” and “sh” may be indicated by the key “s/sh”, compound vowels “an” and “ang” may be indicated by the key “an/ang”, compound vowels “en” and “eng” may be indicated by the key “en/eng”, compound vowels “in” and “ing” may be indicated by the key “in/ing”, compound vowels “un” and “ong” may be indicated by the key “un/ong”. The setting of “initiate fuzzy syllables” is a conventional setting of the input mode, which shall not be described any further.

In the embodiment shown in FIG. 5, since the key “z/zh” indicates initial consonant “z” and initial consonant “zh”, the key “c/ch” indicates initial consonant “c” and initial consonant “ch”, the key “s/sh” indicates initial consonant “s” and initial consonant “sh”, the key “an/ang” indicates compound vowel “an” and compound vowel “ang”, the key “en/eng” indicates compound vowel “en” and compound vowel “eng”, the key “in/ing” indicates compound vowel “in” and compound vowel “ing”, the key “un/ong” indicates compound vowel “un” and compound vowel “ong”, it corresponds that the fuzzy syllables are initiated. Hence, the pinyin inputted by the user may be fed back only if the processing is performed according to the method for inputting Chinese characters shown in FIG. 3, so as to obtain a result of inputting Chinese characters.

In the embodiments shown in FIGS. 4 and 5, functional keys of electronic apparatuses, such as the key “*” and the key “#”, are not shown. In this embodiment, such functional keys may be arranged at any positions convenient for operation in the initial consonant inputting region and the compound vowel inputting region, and this embodiment is not limited thereto.

In an embodiment, the keys in the keyboard of this embodiment are hardware keys. In another embodiment, the keys in the keyboard of this embodiment are touch-screen virtual keys.

According to the keyboard of this embodiment, in combination with the method for inputting Chinese characters of the embodiment shown in FIG. 3, when a user inputs Chinese characters, the complete input of a Chinese character may be realized by only pressing the initial consonant key and the compound vowel key(s) to which the Chinese character corresponds, thereby greatly improving the efficiency of input in comparison with the full spelling input mode of the prior art, wherein each letter to which the complete pinyin of the Chinese character corresponds to needs to be pressed so as to realize the complete input of a Chinese character. For example, in inputting a sentence “ [symbol] ”, it only needs eight times of pressing if the keyboard of this embodiment and the method for inputting Chinese characters are used; however, in the full spelling input mode of the prior art, it needs twelve times of pressing.

### Embodiment 3

According to a further embodiment of the present invention, there is provided an electronic apparatus. The electronic apparatus includes, in addition to its original components and functions, the keyboard of embodiment 2 of the present invention, for a user to input Chinese characters by using the method for inputting Chinese characters of embodiment 1 of the present invention.

The structure of each of the keys of the keyboard of the electronic apparatus may be realized by using an existing structure of a key, and the embodiments of the present invention are not limited thereto.

The relationship of connection between each of the keys of the keyboard of the electronic apparatus and the circuit board of the electronic apparatus are the same as that of the prior art, which shall not be described any further.

Since the electronic apparatus of this embodiment uses the keyboard of embodiment 2, in combination with the method for inputting Chinese characters of embodiment 1, the contents of the method for inputting Chinese characters and the keyboard are incorporated herein and shall not be described any further, since they are described in detail in embodiments 1 and 2.

With the electronic apparatus of the present invention, fast input of Chinese characters may be realized, and it is more suitable for the habits of users, thereby, improving the efficiency of input.

The preferred embodiments of the present invention are described above with reference to the figures. Many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

It should be understood that each of the parts of the present invention may be implemented by hardware, software, firmware, or a combination thereof. In the above embodiments, multiple steps or methods may be realized by software or firmware that is stored in the memory and executed by an appropriate instruction executing system. For example, if it is realized by hardware, it may be realized by any one of the following technologies known in the art or a combination thereof as in another embodiment, a discrete logic circuit having a logic gate circuit for realizing logic functions of data signals, application-specific integrated circuit having an appropriate combined logic gate circuit, a programmable gate array (PGA), and a field programmable gate array (FPGA), etc.

The description or blocks in the flowcharts or of any process or method in other manners may be understood as being indicative of including one or more modules, segments or parts for realizing the codes of executable instructions of the steps in specific logic functions or processes, and that the scope of the preferred embodiments of the present invention include other implementations, wherein the functions may be executed in manners different from those shown or discussed, including executing the functions according to the related functions in a substantially simultaneous manner or in a reverse order, which should be understood by those skilled in the art to which the present invention pertains.

The logic and/or steps shown in the flowcharts or described in other manners here may be, for example, understood as a sequencing list of executable instructions for realizing logic functions, which may be implemented in any computer readable medium, for use by an instruction executing system, device or apparatus (such as a system including a computer, a system including a processor, or other systems capable of extracting instructions from an instruction executing system, device or apparatus and executing the instructions), or for use in combination with the instruction executing system, device or apparatus. As used herein, “a computer readable medium” can be any device that can contain, store, communicate with, propagate or transmit programs for use by an instruction executing system, device or apparatus, or can be used with the instruction executing system, device or apparatus. A computer readable medium may be, for example, but not limited to, a magnetic, optical, electromagnetic, infrared or semiconductor system, device, apparatus, or a propagation medium. More particular examples (inexhaustive lists) of a computer readable medium may comprise the following: an electrical connecting portion (electronic device) having one or more wirings, a portable computer hardware box (magnetic device), a random access memory (RAM) (electronic device), a read-only memory (ROM) (electronic device), an erasable programmable read-only memory (EPROM or flash memory) (electronic device), an optical fiber (optical device), and a portable compact disk read-only memory (CDROM) (optical device). Furthermore, a computer readable medium may be paper or other appropriate media on which the programs may be printed, as the programs may be obtained electronically through scanning optically the paper or other appropriate media and then compiling, interpreting, or processing in other appropriate manners, as necessary, and then the programs are stored in the computer memory.

The above literal description and drawings show various features of the present invention. It should be understood that a person of ordinary skill in the art may prepare suitable computer codes to carry out each of the steps and processes described above and illustrated in the drawings. It should also be understood that the above-described terminals, computers, servers, and networks, etc. may be any type, and the computer codes may be prepared according to the disclosure contained herein to carry out the present invention by using the devices.

Particular embodiments of the present invention have been disclosed herein. Those skilled in the art will readily recognize that the present invention is applicable in other environments. In practice, there exist many embodiments and implementations. The appended claims are by no means intended to limit the scope of the present invention to the above particular embodiments. Furthermore, any reference to “a device to . . . ” is an explanation of device plus function for describing elements and claims, and it is not desired that any element using no reference to “a device to . . . ” is understood as an element of device plus function, even though the wording of “device” is included in that claim.

Although a particular preferred embodiment or embodiments have been shown and the present invention has been described, it is obvious that equivalent modifications and variants are conceivable to those skilled in the art in reading and understanding the description and drawings. Especially for various functions executed by the above elements (portions, assemblies, apparatus, and compositions, etc.), except otherwise specified, it is desirable that the terms (including the reference to “device”) describing these elements correspond to any element executing particular functions of these elements (i.e. functional equivalents), even though the element is different from that executing the function of an exemplary embodiment or embodiments illustrated in the present invention with respect to structure. Furthermore, although a particular feature of the present invention is described with respect to only one or more of the illustrated embodiments, such a feature may be combined with one or more other features of other embodiments as desired and in consideration of advantageous aspects of any given or particular application.

1. A method for inputting Chinese characters, applicable to Chinese characters input on a keyboard, wherein the keyboard comprises
an initial consonant inputting region and a compound vowel inputting region;
the initial consonant inputting region comprising multiple initial consonant keys, with each of the initial consonant keys indicating at least one initial consonant; and
the compound vowel inputting region comprising multiple compound vowel keys, with each of the compound vowel keys indicating at least one compound vowel; and
the method for inputting Chinese characters comprising the steps of:
acquiring corresponding initial consonant and compound vowel(s), in response to the input of an initial consonant key in the initial consonant inputting region and the input of a compound vowel key (or compound vowel keys) in the compound vowel inputting region, or, acquiring corresponding compound vowel, in response to the input of a compound vowel key in the compound vowel inputting region; and
displaying the Chinese character consistent with the combination of the initial consonant and compound vowel(s) or the Chinese character consistent with the compound vowel in accordance with a predefined rule.

2. The method according to claim 1, wherein the initial consonant inputting region is located at the left side of the keyboard, and the initial consonant keys of the initial consonant inputting region are arranged in an array; and
the compound vowel inputting region is located at the right side of the keyboard, and the compound vowel keys of the compound vowel inputting region are arranged in an array.

3. The method according to claim 1, wherein the number of the initial consonant keys of the initial consonant inputting region is 20, and the initial consonant keys are arranged in an array of 4×5; and
wherein the initial consonant “z” and the initial consonant “zh” correspond to an initial consonant key, the initial consonant “c” and the initial consonant “ch” correspond to an initial consonant key, the initial consonant “s” and the initial consonant “sh” correspond to an initial consonant key, and each of other initial consonants corresponds to an initial consonant key.

4. The method according to claim 1, wherein the number of the initial consonant keys of the initial consonant inputting region is 23, and the initial consonants are arranged in an array of 5×5 and wherein each of the initial consonants corresponds to an initial consonant key.

5. The method according to claim 1, wherein the number of the compound vowel keys of the compound vowel inputting region is 20, and the compound vowel keys are arranged in an array of 4×5; and
wherein the compound vowel “an” and the compound vowel “ang” correspond to a compound vowel key, the compound vowel “en” and the compound vowel “eng” correspond to a compound vowel key, the compound vowel “in” and the compound vowel “ing” correspond to a compound vowel key, the compound vowel “un” and the compound vowel “ong” correspond to a compound vowel key, and each of other compound vowels corresponds to a compound vowel key.

6. The method according to claim 1, wherein the number of the compound vowel keys of the compound vowel inputting region is 24, and the compound vowels are arranged in an array of 5×5 and wherein each of the compound vowels corresponds to a compound vowel key.

7. A keyboard, applicable to Chinese characters input, wherein the keyboard comprises:
an initial consonant inputting region, comprising multiple initial consonant keys, with each of the initial consonant keys indicating at least one initial consonant; and
a compound vowel inputting region, comprising multiple compound vowel keys, with each of the compound vowel keys indicating at least one compound vowel.

8. The keyboard according to claim 7, wherein the initial consonant inputting region is located at the left side of the key structure, and the initial consonant keys of the initial consonant inputting region are arranged in an array; and
the compound vowel inputting region is located at the right side of the key structure, and the compound vowel keys of the compound vowel inputting region are arranged in an array.

9. The keyboard according to claim 7, wherein the number of the initial consonant keys of the initial consonant inputting region is 20, and the initial consonant keys are arranged in an array of 4×5; and
wherein the initial consonant “z” and the initial consonant “zh” correspond to an initial consonant key, the initial consonant “c” and the initial consonant “ch” correspond to an initial consonant key, the initial consonant “s” and the initial consonant “sh” correspond to an initial consonant key, and each of other initial consonants corresponds to an initial consonant key.

10. The keyboard according to claim 7, wherein the number of the initial consonant keys of the initial consonant inputting region is 23, and the initial consonants are arranged in an array of 5×5; and wherein each of the initial consonants corresponds to an initial consonant key.

11. The keyboard according to claim 7, wherein the number of the compound vowel keys of the compound vowel inputting region is 20, and the compound vowel keys are arranged in an array of 4×5; and
wherein the compound vowel “an” and the compound vowel “ang” correspond to a compound vowel key, the compound vowel “en” and the compound vowel “eng” correspond to a compound vowel key, the compound vowel “in” and the compound vowel “ing” correspond to a compound vowel key, the compound vowel “un” and the compound vowel “ong” correspond to a compound vowel key, and each of other compound vowels corresponds to a compound vowel key.

12. The keyboard according to claim 7, wherein the number of the compound vowel keys of the compound vowel inputting region is 24, and the compound vowels are arranged in an array of 5×5; and wherein each of the compound vowels corresponds to a compound vowel key.

13. An electronic apparatus, comprising the keyboard as claimed in claim 7, for inputting Chinese characters through the keyboard.

14. An electronic apparatus, comprising the keyboard as claimed in claim 8, for inputting Chinese characters through the keyboard.

15. An electronic apparatus, comprising the keyboard as claimed in claim 9, for inputting Chinese characters through the keyboard.

16. An electronic apparatus, comprising the keyboard as claimed in claim 10, for inputting Chinese characters through the keyboard.

17. An electronic apparatus, comprising the keyboard as claimed in claim 11, for inputting Chinese characters through the keyboard.

18. An electronic apparatus, comprising the keyboard as claimed in claim 12, for inputting Chinese characters through the keyboard.
